(19) United States
(12) Patent Application Publication
(10) Pub. No.: US 2010/0193036 A1
(43) Pub. Date: Aug. 5, 2010

(54) Method for Actuating a Solenoid Valve and Associated Device

(75) Inventors: Christoph Haggenmiller, Regensburg (DE); Anton Mayer-Dick, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/679,985

(22) PCT Filed: Sep. 19, 2008
(86) PCT No.: PCT/EP08/62507

§ 371 Date: Mar. 25, 2010

(30) Foreign Application Priority Data
Sep. 25, 2007 (DE) 10 2007 045 779.2

(51) Int. Cl. F16K 31/02

(52) U.S. Cl. 137/1; 251/129.15

(57) ABSTRACT

A method for actuating a solenoid valve generates precise opening and closing times of the solenoid valve. To this end, an actuating current provided for actuating the solenoid valve and applied to an actuating coil of the solenoid valve is already reducing in a reduction phase prior to a switch-off point in time of the solenoid valve relative to a maintained level of the actuating current, at which the solenoid valve is reliably held in an actuating position.

The invention relates to a method for actuating a solenoid valve for high-pressure injection into motor vehicles. The invention also relates to a device for the implementation of the method.

Usually, actuated solenoid valves are used for the direct injection of fuel into automotive engines. Hereby, it is desirable to have a defined, i.e. neither too low nor too high, injection quantity, which can be achieved by precision control of the opening and closing time of the solenoid valve.

The actuation of the solenoid valve usually takes place via a solenoid coil to which an actuating current is applied. The induced magnetic field usually magnetizes a solenoid yoke within the solenoid coil. The resultant magnetic force causes an actuating element functioning as a solenoid armature to move against a spring force toward the yoke into an actuation position.

In current actuation methods, the actuating current is generally controlled in such a way that, in a precharge phase, the actuating current is increased to a level at which still no actuation of the valve takes place and the valve is in a preloaded condition. In a peak phase, the actuating current is briefly set to a high value in order to ensure actuation of the solenoid valve in the shortest possible time. In a subsequent peak-holding phase, the actuating current is held as high as possible until the solenoid valve is reliably actuated. In the subsequent holding phase, the actuating current is set to a lower maintained level at which the solenoid valve is reliably held in the actuation position. At the switch-off time, the actuating current and the energy stored in the actuating coil is dissipated by the application of the highest possible countervoltage in the shortest possible time.

The problem with a conventional actuation of this kind is that the inductance of the solenoid coil causes the actuating current to be maintained for a certain period after the switch-off time so that the actual switching operation of the solenoid valve is delayed. With conventional injectors, there is also the problem that, after the switch-off time, the rapid change of the actuating current in the solenoid coil induces eddy currents which counteract the dissipation of the magnetic field, which in turn delays the switching of the solenoid valve.

This electrical delay caused by eddy currents is in particular problematical when very small injection quantities, and hence very short opening times of the solenoid valve, are desired, since then it is not possible to correct the above delays.

The object underlying the invention is to disclose an actuation method suitable for achieving an as precise as possible setting of the opening time or closing time of a solenoid valve. The invention is also based on the object of disclosing a device which is particularly suitable for performing the method.

With respect to the method, this object is achieved according to the invention by the features of claim 1. According to this, provision is made to further reduce the actuating current in a reduction phase prior to a desired switch-off time relative to a holding level.

The method according to the invention shortens the delay from the switching off of the actuating current to the actual switching of the solenoid valve in two aspects: on the one hand, due to the fact that the actuating current is now lower at the switch-off time compared to in the prior art, less magnetic energy is stored in an actuating coil of the solenoid valve so that the voltage induced on the switching-off of the actuating current decays more rapidly. On the other hand, the electrical delay created by eddy currents in the armature of the actuating coil is approximately proportional to the level of the actuating current at the switch-off time. The reduction of the actuating current at the switch-off time therefore also causes the eddy-current-induced electrical delay to be reduced.

Due to the advantageous shortening of the delay times from the switch-off time until the actual closing of the solenoid valve, the actuation of the solenoid valve according to the invention enables in particular very short opening times, and hence very low injection quantities, to be achieved.

Preferably, the actuating current is reduced in the reduction phase to a level at which the magnetic holding force on its own is no longer sufficient to hold the solenoid valve in the actuating position for lengthy periods and instead the solenoid valve is now only held in the actuating position due to the mechanical inertia and possibly any residual eddy currents until the desired switch-off time. This actuation method is particularly suitable for achieving short opening times, since at the actual switch-off time, the mechanical inertia of the solenoid valve is at least partially overcome, and hence the electrical delay is no longer, or only insignificantly, superimposed by the inertia-induced delay on switching.

Advantageously, the actuating current is reduced in the reduction phase according to prespecified time profile from maintained level to a switch-off level. In this case, the actuating current can in particular be reduced slowly enough to enable a rapid magnetic flow change and any induction voltages induced thereby in the actuating coil to be avoided or at least reduced.

Preferably, hereby, the actuating current is reduced in stages or steps during the reduction phase from maintained level to the switch-off level. In a similarly advantageous alternative version of the method, it is provided that the actuating current is reduced continuously during the reduction phase from the maintained level to the switch-off level.

Advantageously, the actuating current is briefly increased to a maximum in a peak phase, so that the solenoid valve is reliably actuated as quickly as possible.

In a further alternative version of the method, the actuating current is increased in a precharge phase to a level at which the solenoid valve is not yet actuated, but is in a preloaded condition. This reduces the response time during an elevation of the actuating current, so that the solenoid valve can change more quickly from the neutral position to the actuation position.

Advantageously, the actuating current applied to the actuating coil is adjusted by a control system (“closed-loop control”). This is advantageous, since then any possible disturbances to the actuating current can be corrected.

Preferably, directly after the switching-off of the actuation current, a high countervoltage is applied to the actuating coil. This measure ensures that the residual actuating current at the switch-off time is rapidly reduced to zero and the magnetic energy removed from the actuating coil.

As far as the device is concerned, the above object is achieved according to the invention by the features of claim 10.

According to this, the device comprises a power output stage for actuating an actuating coil of a solenoid valve with an actuating current and a control unit for actuating the power output stage which is designed to control the power output stage in such a way that the actuating current is set in accordance with the method described above.

The following explains exemplary embodiments of the invention in more detail with reference to a drawing, which shows:

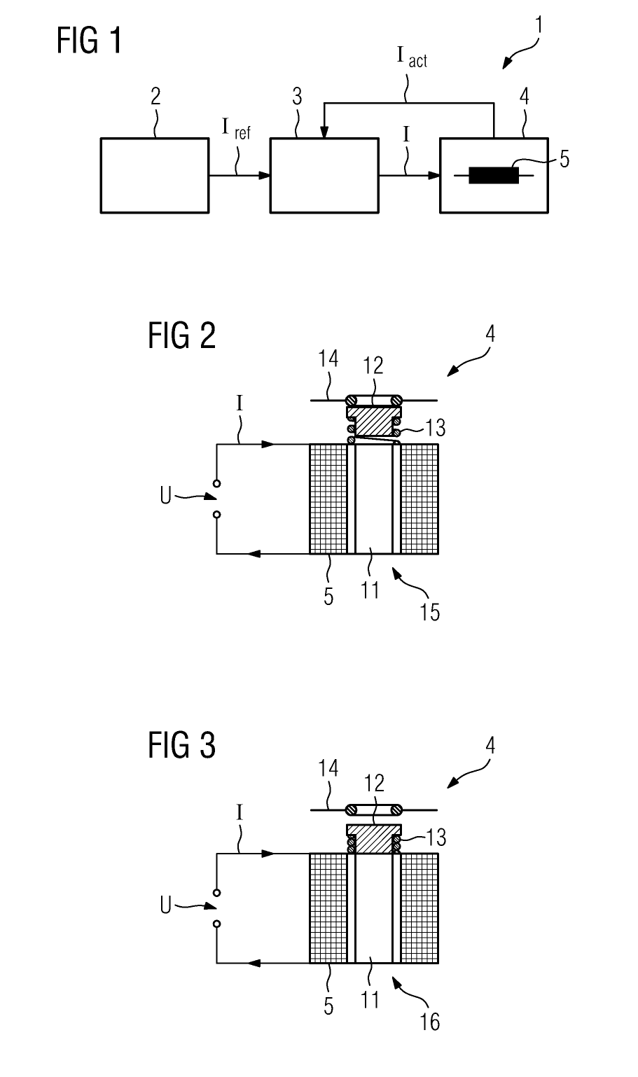

FIG. 1 in a block diagram, a device for actuating a solenoid valve,

FIGS. 2 and 3 in schematic representation, the mode of operation of the solenoid valve,

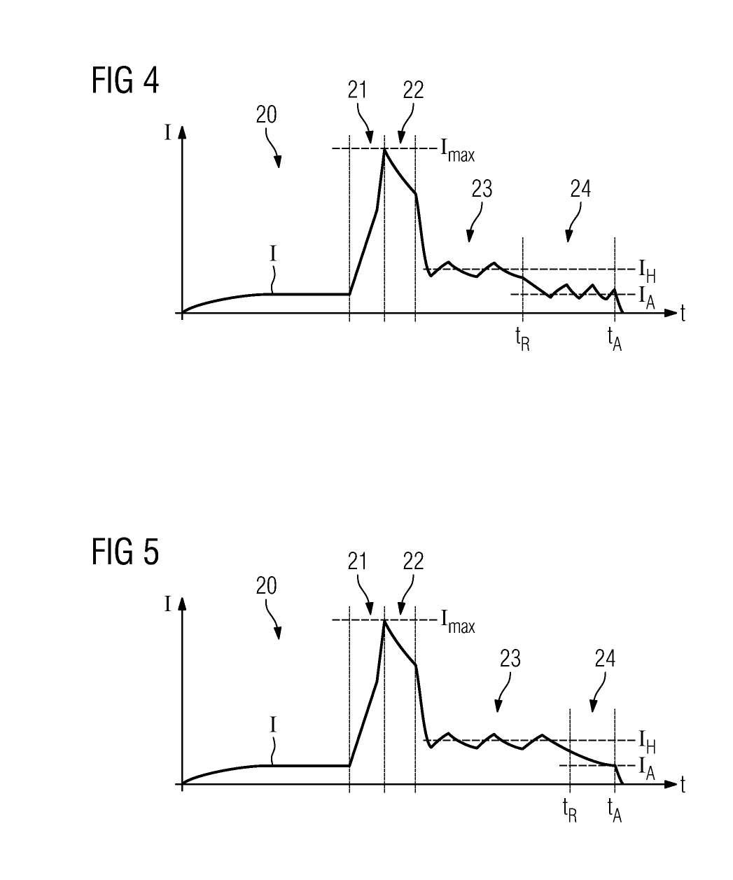

FIG. 4 in a schematic diagram, plotted against the time, the path of an actuating current for the actuation of the solenoid valve according to a first embodiment of the invention, and

FIG. 5 in the representation according to FIG. 4, the path of the actuating current according to a second embodiment of the invention.

Corresponding parts and sizes are always provided with the same reference numbers in all the figures.

FIG. 1 shows a device 1 for actuating a solenoid valve 4. The device substantially comprises a control unit 2, for example, a microprocessor, and a power output stage 3. The power output stage 3 causes a solenoid coil (hereinafter: actuating coil 5) of the solenoid valve 4 to be injected with an actuating current I. A reference value I_{ref} of the actuating current I is preset during the operation of the device 1 by the control unit 2. The value of the actuating current I actually applied to the actuating coil 5 is returned to the control unit 2 as an actual value I_{act}. The actuating current I is regulated by the power output stage 3 by means of a comparison of the actual value I_{act} with the reference value I_{ref}.

FIGS. 2 and 3 show a schematic view of the mode of operation of the solenoid valve 4. The actuating current I is injected into the actuating coil 5 via a terminal voltage U. The actuating current I establishes a magnetic field which magnetizes a yoke 11 of the actuating coil 5. In the case of a small or vanishing actuating current I, and hence a low or non-existent magnetic force, an actuating element 12 is preloaded due to the force of a spring 13 in contact with a sealing surface 14. In this case, the solenoid valve 4 is in a neutral position 15 shown in FIG. 2.

If the actuating current I is increased, the higher magnetic force overcomes the spring force of the spring 13, so that the actuating element 12 is raised from the sealing surface 14 and moved into an actuation position 16 shown in FIG. 3.

FIG. 4 shows the path of the actuating current I, plotted against time t, during a switching operation of the solenoid valve 4. Firstly, in a precharge phase 20, the actuating current I is increased to a level at which the solenoid valve 4 is not yet in the actuation position 16, but in a preloaded condition. In a subsequent peak phase 21, the actuating current I is then increased to a maximum value Iₘₐₓ, which is set as high as possible so that the solenoid valve 4 is actuated in the shortest possible time. A high current value is maintained in a peak-holding phase 22 following the peak phase 21 in order to ensure that the solenoid valve 4 has achieved the actuation position 16. In a subsequent holding phase 23, the actuating current I is now reduced to a holding level 21 which is selected high enough for the solenoid valve 4 to remain reliably in the actuation position 16. The actuating current is maintained at this maintained level I_{H} until shortly before a desired switch-off time t_{A}.

Following the holding phase 23, the actuating current I is reduced in one step (FIG. 4) or several steps at a reduction time t_{R} prior to the switch-off time t_{A} in a reduction phase 24.

Alternatively to this, the actuating current I according to FIG. 5 is reduced in the reduction phase 24 in a chronologically approximately linear profile continuously from the maintained level I_{H} to a switch-off level I_{E}.

In both variants, the actuating current I at the switch-off time t_{A} at which the solenoid valve 4 is to return to its neutral position 15 is already at such a low level that the magnetic force of the actuating coil 5 per se is no longer sufficient to hold the solenoid valve 4 in the actuation position 16. Instead, the path of the current in the reduction phase 24 is selected so that the solenoid valve 4 is only still maintained in the actuation position 16 due to its mechanical inertia and any eddy currents present up to the switch-off time t_{A}.

In both cases, the residual current present after the switching-off will be caused to dissipate rapidly by applying a terminal voltage U opposite to the current flow.

It has been found to be particularly advantageous for the switch-off level I_{A} of the actuating current I to be reduced by approximately 50%, in particular to a value of approximately 0.5 amperes, since then the electrical delay of the switching operation of the solenoid valve 4 is reduced so greatly that the delay is now only effected by the mechanical inertia of the actuation element 12 so that the delay now only can be further reduced by constructive measures.

1-10. (canceled)

11. A method of actuating a solenoid valve, the method which comprises:
supplying an actuating current for actuating the solenoid valve to an actuating coil of the solenoid valve;
maintaining the actuating current at a holding level configured to reliably hold the solenoid valve in an actuating position; and
reducing the actuating current relative to the holding level in a reduction phase prior to a switch-off time of the solenoid valve.

12. The method according to claim 11, which comprises, in the reduction phase, reducing the actuating current so far that the solenoid valve is only held in the actuating position by mechanical inertia and any remaining eddy currents until the switch-off time.

13. The method according to claim 11, which comprises reducing the actuating current in accordance with a prespecified time profile.

14. The method according to claim 11, which comprises reducing the actuating current chronologically in steps.

15. The method according to claim 11, which comprises reducing the actuating current chronologically continuously.

16. The method according to claim 15, which comprises reducing the actuating current linearly.

17. The method according to claim 11, which comprises increasing the actuating current in a peak phase to a maximum at which the solenoid valve is reliably actuated.

18. The method according to claim 11, which comprises increasing the actuating current in a precharge phase only to a level at which the solenoid valve is not yet actuated, but is in a preloaded condition.

19. The method according to claim 11, which comprises adjusting the actuating current to a reference value by comparison with an actual value.

20. The method according to claim 11, which comprises applying a terminal voltage at the switch-off time, the terminal voltage being inverse to a voltage induced in the actuating coil.

21. A device for actuating a solenoid valve having an actuating coil, the device comprising:
a power output stage connected to the actuating coil of the solenoid valve and configured to supply the actuating with an actuating current; and
a control unit for driving said power output stage, said control unit being configured to actuate said power output stage in such a way that the actuating current is already reduced in a reduction phase before a switch-off time of the solenoid valve relative to a holding level of the actuating current, at which the solenoid valve is reliably held in an actuating position thereof.
